(19) United States
(12) Patent Application Publication
(10) Pub. No.: US 2003/0101639 A1
(43) Pub. Date: Jun. 5, 2003

(54) Gel candle composition and holographic assembly

(76) Inventor: Robert J. Schinski, Renton, WA (US)

Correspondence Address: Dean A. Craine, P.S., Suite 140, 400-112th Ave. N.E., Bellevue, WA, 98004, US

(21) Appl. No.: 09/998,436

(22) Filed: Nov. 30, 2001

(51) Int. Cl. C10L 7/00; C11C 5/00

(52) U.S. Cl. 44/275

(57) ABSTRACT

A gel candle assembly comprising a gel candle made of three different viscosity mineral oils and a polymer to produce a self-supporting structure. The gel candle is transparent and manufactured into an elongated polyhedron or cylinder. It is placed onto a plastic base with perpendicularly aligned side walls, a holographic liner inside the base, and a transparent cover which covers the gel candle and selectively attaches to the plastic base. When in use, the light from the candle flame is refracted through the candle and reflected from the holographic liner. The light reflected from the holographic liner produces a plurality of spectrums visible through the gel candle. An optional protective plastic spacer is included that is intended to rest on the top surface of the candle when the candle is not in use. Optional color, fragrance, and glitter may be added to the candle gel.

### BACKGROUND OF THE INVENTION

1. Field of the Invention

This invention pertains to candles, and more specifically, to candles formed of transparent gels.

2. Description of the Related Art

Candles have been used for thousands of years as a source of light or heat, or for ceremonial purposes. Candles have been adapted to produce scent and /or decoration and are now particularly popular. While traditional wax candles can be modified to many different shapes, colors, and fragrances, they are unavoidably opaque and thus are limited in ornamental capacity. Liquid oil candles permit the addition of dispersed decorative particles throughout the candle, yet cannot be formed into freestanding shapes, i.e. pillars.

Recently, gel candles made of highly refined, high viscosity hydrocarbon oils (mineral oils poured into transparent glass containers) have become popular. Some of the main advantages of gel candles are their easy manufacturing, longer life and low soot production. A leading company in this technology is Penreco Company, located in Houston, Tex., which has obtained U.S. Pat. No. 5,879,694 protection for a transparent gel candle composition that has suitable Theological properties to produce a firm candle using a hydrocarbon oil, and at least one copolymer selected from a group consisting of a triblock polymer, a radial block copolyer, a multiblock copolymer, and an optional diblock polymer.

A major disadvantage of the gel candle compositions made of mineral oil is they produce excessive soot, have insufficient rheological properties for a pillar candle that remaind upright as it bums, and has an insufficient margin between the flashpoint and melting temperatures. These gel candle compositions melt in high ambient temperatures thereby making shipment of pillar candles into hot climates impractical. Because most candle manufactures ship gel candles to different climates, most gel candle manufactures avoid pillar candles and only place gel candles in rigid containers. As a result, the beauty and enjoyment of a pillar candle made of these gel candle compositions are not exploited.

Ideally, what is needed is an improved gel candle composition is that is produces less soot, has better rheological properties for a pillar candle, and is temperature-tolerant. What is also needed is a pillar candle made of the improved gel candle composition that is more decorative than standard gel candles.

### SUMMARY OF THE INVENTION

It is an object of the present invention to provide an improved gel candle composition that produces less soot and has improved rheological properties for making pillar candles.

It is another object of the present invention to provide an improved gel candle composition that is more temperature-tolerant than gel candle compositions found in the prior art.

It is another object of the present invention to provide a decorative gel candle assembly that uses a gel candle made with the above-referenced improved gel candle composition.

These and other objects of the present invention which will become apparent are met by the decorative gel candle assembly disclosed herein comprising a self-supporting gel candle made of an improved gel candle composition that is a mixture of three different viscosity mineral oils and a stabilizing polymer. Also disclosed herein is a decorative gel candle made with the gel candle composition that is clear or transparent and manufactured as a pillar candle. In the preferred embodiment, the gel candle is supported on a rigid base and has a holographic liner that disperses candle light into a plurality of prisms or spectrums. Extending over the gel candle and selectively attached to the base is a cover which protects the gel candle during transport and prevents dust and dirt from accumulating on the top and sides of the gel candle.

An optional spacer is positioned over the top surface of the gel candle to hold the gel candle inside the cover. During assembly, the cover is disposed over the spacer of the gel candle, and attached to the base to securely hold the gel candle in place during shipment. The cover and spacer are then selectively removed by the user during use.

When in use, the light from the candle flame is transmitted through the gel candle and refracted through the gel candle side and base facets. Some of the refracted light is transmitted onto the holographic liner which disperses the light into a plurality of spectrums which again are refracted into gel candle which gives the viewer the impression of suspended colored particles. When the holographic liner is larger than the gel candle, a plurality of spectrums is produced on the section of the holographic liner that extends outward from the gel candle and to the sidewall of the base. Optional color, fragrance, and decorative glitter that reflects both the candle light and the refracted light from the holographic liner may be added to the gel candle.

### DESCRIPTION OF THE DRAWINGS

FIG. 1 is perspective view of the gel candle holographic assembly.

FIG. 2 is a side elevational view of the invention.

FIG. 3 is a side elevational view of the invention showing the transmission patterns of the candlelight.

### DESCRIPTION OF THE PREFERRED EMBODIMENT(S)

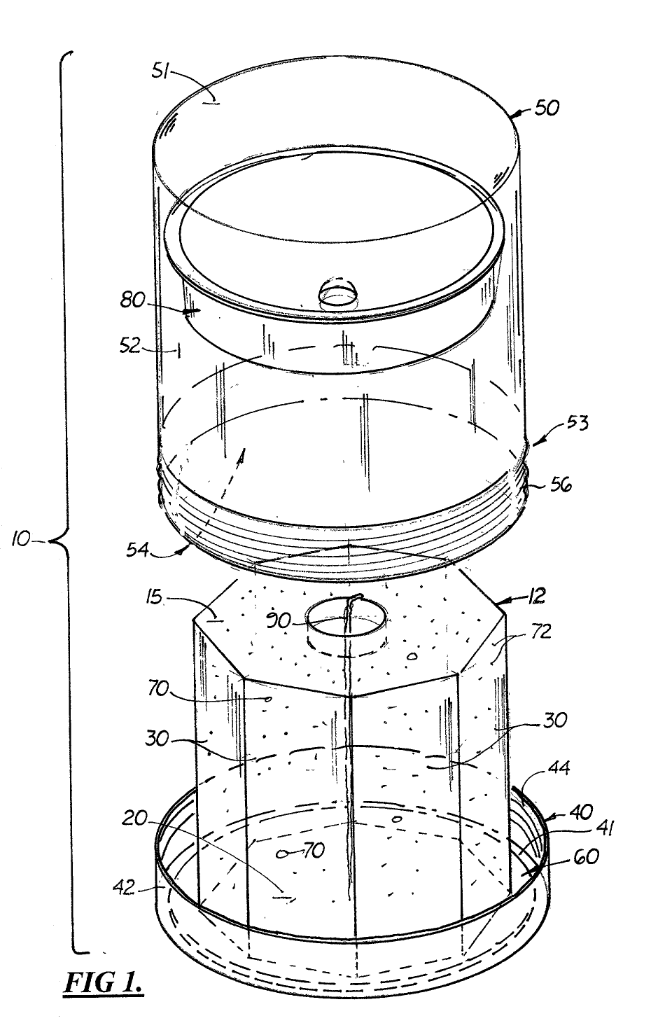

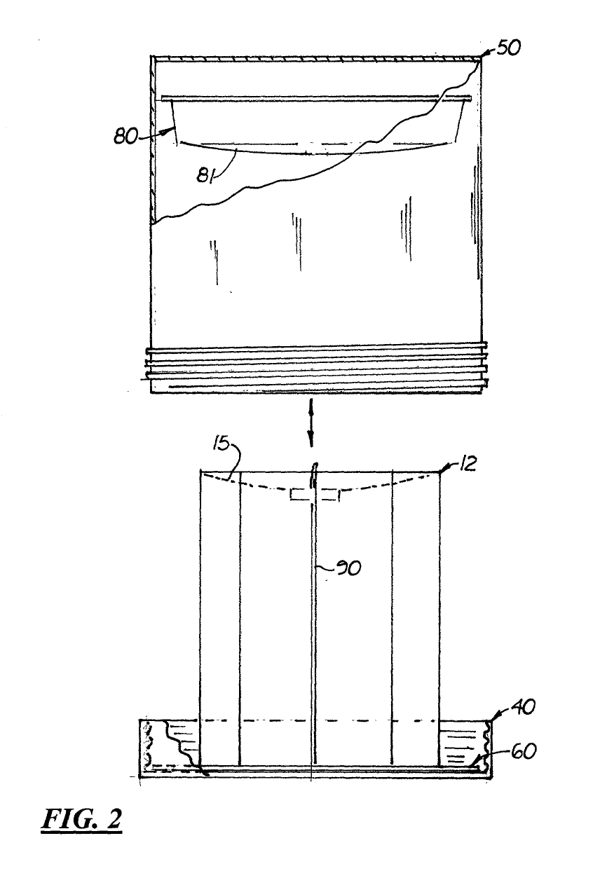

Referring to the accompanying FIGS. 1-3, there is shown and described a gel candle holographic assembly 10 comprising a gel candle 12 located on a base 40, a holographic liner 60 disposed over the base 40 and under the gel candle 12, and a cover 50 that selectively attaches to the base 40. The gel candle 12 is made of an improved gel candle composition designed to produce clear or transparent gel candles that can be manufactured as pillar candles. More specifically, the improved gel candle composition is designed to have a higher melting temperature, longer burning life, and minimal soot production.

The improved gel candle composition is similar to the gel candle composition disclosed in U.S. Pat. No. 5,879,684 and incorporated herein, comprising a high viscosity hydrocarbon oil, and at least one copolymer selected from a group consisting of a triblock polymer, a radial block copolyer, a multiblock copolymer, and an optional diblock polymer. In this invention, hydrocarbon oil is replaced with a mixture of a first mineral oil (65-75% wt.), a second mineral oil, and a third mineral oil, all mixed together with a thermoplastic polymer to produce a heterophase thermally reversible mineral oil gel. The first mineral oil used (58% to 81% wt.)to manufacture the gel candle composition is a medium range viscosity (106.5-125.5 cSt.) such as the mineral oil product manufactured and sold by Penreco Company under the trademark DRAKEOL-600. The second mineral oil used (89%) is a higher viscosity (180-240 cSt) mineral oil produce manufactured and sold by Witco Company located in and sold under the trademark HYDROBRITE-1000. The third mineral oil used (2 to 6% wt) is a lower viscosity mineral oil (72-79.5 cSt.) is a mineral oil product manufactured and sold by Penreco Company under the trademark DRAKEOL 34. The stabilizing polymer is a thermoplastic polymer manufactured and sold by Kraton Polymers (12% to 16% wt.) located in Belpre, Ohio (USA). During manufacturing, the mineral oils and polymer are heated and mixed together and then poured into suitable molds.

It is widely known that many mineral oils have low flash points and create a relatively large amount of soot. Experiments performed by the Inventor have shown that the flash point and amount of soot from a mineral oil are inversely related to its viscosity. By using mineral oils that have different viscosities, the usual flash point and amount of soot of a gel candle can be controlled. In order to manufacture a pillar gel candle, the correct balance of mineral oils must be used so that the average viscosity of the gel candle composition and the gel candle's overall flash point are relatively high and the amount of soot created is relatively low. The above referenced combination of mineral oils and their viscosity ranges, and proportions produce a gel candle composition that produces a safe, pillar candle that produces a relatively low amount of soot and is high temperature tolerant.

Because all of the mineral oils are white mineral oils thereby producing a clear transparent, gel candle 12 that has a gelatin-like, semi-rigid appearance and texture. In the preferred embodiment, the gel candle 12 is manufactured into an elongated polyhedron structure with a polygonal top surface 15, a corresponding polygonal bottom surface 20, a plurality of at least four side facets 30, and a wick 90. It should be understood that the gel candle 12 could be manufactured in other shapes (i.e. cylinders). A conventional cotton wick 90 is centrally aligned in the gel candle 12 and extends from the bottom surface 20 to a point about ¼ inch above the center of the top surface 15. The top surface 15 is slightly concave caused by shrinkage of the gel candle composition during manufacture.

The base 40 includes a circular planar bottom member 41 with an upward extending, perpendicularly aligned side wall 42 defining a central cavity 43. Formed on the inside surface of the side wall 42 are threads 44. In the preferred embodiment, the base 40 is made of plastic but may be made of any durable material.

Disposed over the bottom member 41 is a holographic liner 60 made of holographic paper designed to cover the entire inside surface of the bottom member 41of the base 40. In the preferred embodiment, the holographic paper is a laminated paper stock with an upper metallized layer and a diffusing, grated image created therein. In the preferred embodiment, the liner 60 is circular and covers the entire bottom member 41 of the base 40. The liner 60 is designed to produce random or organized patterns of spectrums throughout the gel candle 12.

The cover 50 is designed to cover the gel candle 12 and hold the gel candle 12 on the base 40 during shipping. In the preferred embodiment, the cover 50 is an inverted cylindrical tempered glass or transparent plastic jar, having a top surface 52 with a pendant side wall 51 and external threads 56 formed near the lower section 53. Formed inside the cover 50 is an inner cavity 54 on which the shorter gel candle 12 is positioned. The threads 56 matingly engage with the threads 44 of the base 40 to selectively hold the cover 50 tightly on the base 40.

An optional clear, plastic, disc-shaped, protective spacer 80 may be placed on the top surface 15 of the gel candle 12 to prevent the gel candle 12 from moving longitudinally inside the cover 50. In the preferred embodiment, the spacer 80 is an inverted cap-like structure with a convex lower surface that fits into the top surface of the gel candle 12. The spacer 80 is also approximately the same diameter as the gel candle 12 and made of transparent plastic.

Colorants, fragrances, and decorative additives, gas bubbles 70, and metallic glitter 72 may be dispersed randomly throughout the gel candle 12 to deflect and refract light.

The gel candle 12 has a tacky bottom surface which holds the gel candle 12 in position over the base 40. No additional adhesives are needed.

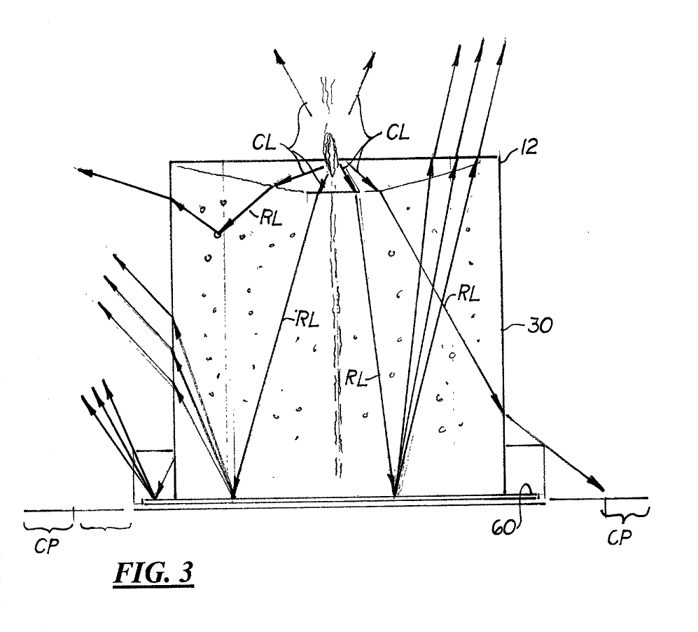

As shown in FIG. 3, when the wick 90 is lit, the candle light (denoted CL) from the flame is transmitted into the air and through the gel candle 12. As the candle light (CL) is transmitted through the gel candle 12, it is refracted. Some of the refracted light (RL) is travels to the side facets 30 creates a circular pattern of light (denoted CP) surrounding the base 40. Because of optical interference, the circular pattern of light (CP) is divided into sixteen, evenly dispensed lighted sections alternating in intensity. The area of the circle immediately adjacent to the base 40 is dark causing a circular shadow (denoted as S) to be cast by the side wall 42 on the base 40. Some of the refracted light (RL) is transmitted to the section of liner 60 located under the gel candle 12 and some of the refracted light (RL) travels through the side facets 30 and is transmitted onto the uncovered section of the liner 60. When the refracted light (RL) hits the liner 60, it also undergoes diffraction which divides the refracted light (RL) into a plurality of spectrums which is reflected directly to the viewer or through the gel candle 12.

In the preferred embodiment, the gel candle 12 is transparent with minute, light-reflecting, multi-colored, non-combustible glitter particles imbedded throughout. The gel candle 12 includes a single, center cotton wick 90 that measures approximately 3¼ inches in length. The octagonal top surface 15 and bottom surface 20 of the gel candle 12 measures approximately 3¼ inches in diameter. There are eight side facets 30 which each measure approximately 1½ inches in width and 3 inches in height. The protective cover 50 is transparent plastic and the base 40 is opaque black plastic. The cover 50 and base 40 measure approximately 4½ inches in diameter. The cover 50 is approximately 4 inches in height. The side wall 42 on the base 40 is approximately ¾ inch in height. The holographic liner 60 is circular and measures approximately 4 ⅜ inches in diameter. A clear, plastic, concave, protective spacer 80 rests upon the top surface 15 when the gel candle 12 is not in use and measures approximately 4¼ inches in diameter. It should be understood that the gel candle 12 can be manufactured in other shapes and sizes.

In compliance with the statute, the invention described herein has been described in language more or less specific as to structural features. It should be understood, however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance

I claim:

1. A gel candle composition, comprising:
a. a first mineral oil having a viscosity in a range of 106.5 to 125.5 (cSt) and in the amount between 58% to 81% by weight;
b. a second mineral oil having a viscosity in a range of 180 to 240 (cSt) and in the amount of 5% to 20% by weight;
c. a third mineral oil having a viscosity in a range of 72 to 79.5 (cSt) and in the amount of 2% to 6% by weight; and,
d. a stabilizing polymer in a range of 12% to 16% by weight.

2. A holographic gel candle assembly, comprising:
a. a base having an upward extending side wall and a bottom surface;
b. a holographic liner located over said bottom surface of said base, said holographic liner having a diffusing, grated image created therein that reflects light;
c. a transparent gel candle disposed over said holographic liner; and,
d. a protective cover selectively attached to said base and used to cover said gel candle.

3. The holographic gel candle assembly, as recited in claim 2, further including glitter disposed inside said gel candle.

4. The holographic gel candle assembly, as recited in claim 2, wherein said protective cover is threadingly connected to said side wall on said base.

5. The holographic gel candle assembly, as recited in claim 9 wherein said gel candle is made of a mixture of first, second, and third mineral oils having different viscosity ranges and a polymer.

6. The holographic gel candle assembly, as recited in claim 5 wherein said first mineral oil has a viscosity in the range of 106.5 to 125.5 cSt.

7. The holographic gel candle assembly, as recited in claim 6 wherein said second viscosity mineral oil has a viscosity in the range of 180 to 240 cSt.

8. The holographic gel candle assembly, as recited in claim 7 wherein said third mineral oil has a viscosity in the range of 72% to 79.5% cSt.

9. The holographic gel candle assembly, as recited in claim 8 wherein said polymer is approximately 14% weight.
